(19) United States
(12) Patent Application Publication
(10) Pub. No.: US 2009/0133330 A1
(43) Pub. Date: May 28, 2009

(54) WINDOW OR DOOR

(75) Inventor: Thomas Buchhalter, Niederkassel (DE)

Correspondence Address: DARBY & DARBY P.C., P.O. BOX 770, Church Street Station, New York, NY, 10008-0770, US

(73) Assignee: WERU AG, Rudersberg (DE)

(21) Appl. No.: 11/817,174

(22) PCT Filed: Feb. 27, 2006
(86) PCT No.: PCT/EP06/01797

§ 371 Date: Jun. 30, 2008

(30) Foreign Application Priority Data
Feb. 25, 2005 (EP) 05101470.2
Apr. 22, 2005 (DE) 20-2005-006-796.2
Jun. 27, 2005 (DE) 10-2005-029-860.5

(51) Int. Cl. E06B 7/28

(52) U.S. Cl. 49/70

(57) ABSTRACT

A window or door is provided with a wing frame for encasing a pane of glass and with an olive-shaped window or door fitting which has a handle fitting, in which a handle is swivellably stored, and which is equipped with a module housing to accommodate a monitoring and alarm module which possesses sensor devices and an evaluation unit. The module housing is arranged sunk in a recess of the wing frame.

This is a U.S. National Phase application under 35 U.S.C. §371 of International Application No. PCT/EP2006/001797, filed Feb. 27, 2006 and claims the benefit of European Patent Application No. 05101470.2, filed on Feb. 25, 2005, German Patent Application DE 20 2005 006 796.2, filed on Apr. 22, 2005, and German Patent Application No. 10 2005 029 860.5, filed on Jun. 27, 2005. The International Application was published in German on Aug. 31, 2006 as WO 2006/089797 under PCT Article 21 (2).

The present invention relates to a window or a door and to an olive-shaped window or door fitting for such a window or such a door.

### BACKGROUND

With such a window or with such a door as has become known from DE 296 03 917 U1, the module housing accommodating the monitoring and alarm module is connected as separate housing to a housing for the handle fitting and together with this is fitted onto the surface of the wing frame, wherein a handle plug penetrates, and extends beyond, both the handle fitting housing and the module housing in order to then be connected rotation-resistant to the closing mechanism in the wing frame in already known manner.

With this known embodiment, the handle plug connected rotation-resistant to the swivellable handle must have an excess length corresponding to the height of the module housing. Moreover, the module housing fitted onto the inner surface of the wing frame brings with it the danger that the monitoring and alarm module is already visible to potential intruders from the outside of the wing frame, added to which is the fact that this fit offers a design which is not acceptable to everyone.

### SUMMARY OF THE INVENTION

An object of the present invention is to produce a window or a door or an olive-shaped window fitting or door fitting of the type named at the outset in which handles such as are customary in other windows or doors can be used and lead to an acceptable design.

By the measures according to the invention it is achieved that the wing frame concerned looks the same from the outside in the handle area, regardless of whether an olive-shaped window or door fitting with or without a monitoring and alarm module is provided. In purely design terms this also means that in both cases the handle or handle plug can be formed in the same way.

A form that is advantageous in terms of production engineering results if the handle fitting forms a structural unit with the monitoring and alarm module or its module housing.

A further advantageous form results if one of the sensor devices has a contactor and a magnet arranged adjacent to the module housing on the fixed frame of the window or door, as through this spatial arrangement the magnet to be allocated can be brought into the immediate vicinity of the monitoring and alarm module and thus a weaker magnetic field is sufficient, which simultaneously increases responsiveness if there is an unauthorized attempt at opening.

Further details of the invention are to be found in the following description in which the invention is described and illustrated in more detail with the help of the embodiment example represented in the drawing.

### BRIEF DESCRIPTION OF THE DRAWINGS

There are shown in:

FIG. 1 a perspective view of a preferred embodiment example of the invention,

FIG. 2 a partial longitudinal section through the monitoring and alarm module, but with the olive-shaped fitting attached, and

FIG. 3 a section along the line III-III of FIG. 2.

### DETAILED DESCRIPTION

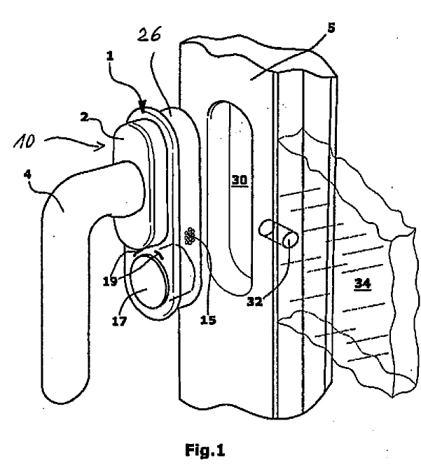

FIG. 1 shows an olive-shaped window or door fitting 10 with a handle 4 housed swivellable in a handle fitting 2 and with an autonomous monitoring and alarm module 1 arranged in a module housing 26. The monitoring and alarm module 1 has its own power supply 18 and is therefore independent of the power feed.

FIG. 1 shows an installation version for integrating the monitoring and alarm module 1 in the frame 5 of a window or door wing. The monitoring and alarm module is arranged sunk into a recess 30 of the wing frame 5, with the result that the olive-shaped window or door fitting 10 sits on the wing frame 5 like a standard version with no alarm device.

The installation version is shown in which the olive-shaped window or door fitting 10 is of conventional construction, wherein a handle plug or plug-in locking part 6 is pushed, rotation-resistant, with the handle 4, through the monitoring and alarm module 1 and is fitted jointly with this.

The olive-shaped window or door fitting 10 can however also form a structural unit with the monitoring and alarm module 1.

The monitoring and alarm module 1 is provided with a handling noise sensor 15 which is used as a glassbreak sensor and which is directed towards a pane of glass 34 and can selectively record sound frequencies which occur when glass is broken. If glass is broken, an alarm signal is transmitted to an evaluation device 24. The handling noise sensor 15 operates particularly reliably if it is arranged sunk into the recess 30, as it is then largely shielded from interfering noises.

In order even to better transmit to the handling noise sensor the sound frequencies occurring when glass is broken, a sound duct 32 can be provided in the wing frame 5, running between the side glass edge of the pane of glass 34 and ending opposite the handling noise sensor 15 in the module housing 26.

The module housing 26 can furthermore have on its front an integrated acoustic signal transmitter 17 which for example consists of a siren. Alternatively or additionally visual signal transmitters, such as for example a stroboscope light or LED lights, can also be provided.

Finally, on the front of the module housing 26, several status displays 19 can be arranged which can display the status of the battery or of the cell 18 and the status of the monitoring and alarm module 1 or of the evaluation unit 24. For example it could also be displayed whether there is a radio link to a central monitoring station. The monitoring and alarm module 1 forms an autonomous alarm system which is independent of the power supply and functions fully automatically. No activation or deactivation of the monitoring and alarm module 1 is necessary. Malfunctions are almost completely ruled out. Even in the case of sabotage e.g. if high-intensity radio waves are superimposed, at least the triggering of a local alarm is still ensured. Further protection against sabotage can be provided by a field-strength measurement sensor which operates an alarm if measured field-strength values change.

It is understood that the olive-shaped window or door fitting 10 with the monitoring and alarm module 1 can also be used autonomously without a central monitoring station and radio transmission of report signals to this.

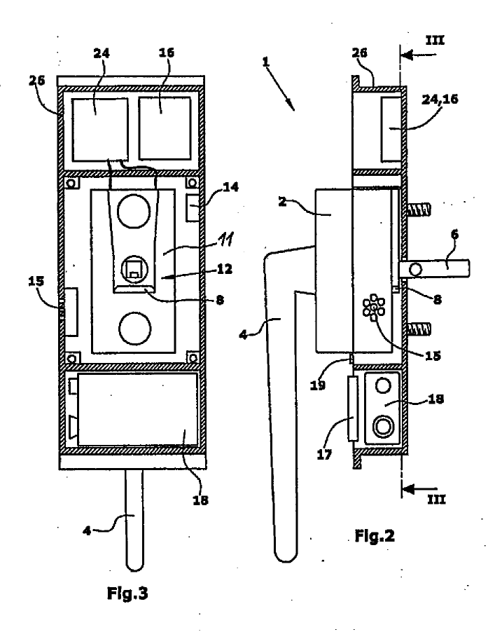

FIGS. 2 and 3, which start from a module housing 26 fitted onto the wing frame 5, show details of the monitoring and alarm module 1 as is also used in the preferred embodiment example of the invention according to FIG. 1.

The monitoring and alarm module 1 serves in particular to secure windows and doors encased in a wing frame 5, with a swivellable handle 4 housed in a handle fitting 2 and with a, here replaceable, handle plug or plug-in locking part 6, connected to the handle 4. A sensor device in the module housing 26 detects the swivel actuation of the handle 4 with a first sensor 8 and delivers a first detection signal to the evaluation device 24.

A signal-triggering element 12 is arranged in the plug-in locking part 6, wherein the first sensor 8 is attached to the plug-in locking part 6 vis-à-vis the signal-triggering element 12 such that, when the handle 4 is moved out of a predefined swivel position, the first sensor 8 delivers the first detection signal to the evaluation device. Arranged in the module housing 26 is a second sensor 14 which, when the window or door wing is in the open position, supplies a second detection signal to the evaluation device 24. The evaluation device 24 recognizes all locking states from the combination of the two detection signals.

The monitoring and alarm module 1 makes it possible not only to monitor the swivel actuation of the handle 4 but also to analyze the handle position and send a corresponding report signal.

The evaluation device 24 receives the signals from all the sensors 8, 14, 15 and from these can recognize the locking state of the handle. Even if the window or the door is opened without the handle 4 being actuated, there is at least a second detection signal, with the result that in this case too a corresponding report signal can be generated.

It can be provided that a transmitter 16 transmits the detection signals or the report signal of the evaluation device 24 wirelessly to the central monitoring station.

It is provided here that the first sensor 8 detects the position of the plug-in locking part 6 in contact-less manner. Such a contact-less recording of the position of the plug-in locking part 6 is wear-free and extensively protected against interfering influences. Alternatively the position of the plug-in locking part 6 can be mechanically scanned.

The evaluation device 24 consists of a logic circuit which generates a report signal differentiated according to the incoming detection signals.

The sensor 16 can be integrated into the handle fitting 2 with the result that, to install the monitoring device according to the invention, it is merely necessary to replace the handle fitting 2 with the plug-in locking part 6. The power supply is in this case likewise integrated into the handle fitting 2.

The first sensor 8 preferably consists of a contactor which detects the position of a magnet attached in or to the plug-in locking part 6 as a signal-triggering element 12. The first sensor 8 consists of a sealed-contact switch which encloses the plug-in locking part 6 in a U-shape or circularly. It is possible to monitor different swivel positions of the handle with a single sensor 8. When using an N/O contact as sealed-contact switch, the switch is open in a swivel position of the handle 4 in which the magnet at the plug-in locking part 6 is opposite the sealed-contact switch, wherein the sealed-contact switch is closed as soon as the handle 4 is swiveled slightly out of this position.

The sealed-contact switch consists of a switch body lying opposite the signal-triggering element 12 when the handle 4 is in the closed position and projecting at right-angles or circularly from this switch body.

The second sensor 14 in the module housing 26 possesses a magnet switch which is actuated by a magnet attached to the fixed frame of the window or door. The second sensor 14 thus establishes whether the window or the door has been opened.

Furthermore a position sensor integrated into the monitoring and alarm module 1 for roller shutters can transmit a third detection signal to the evaluation device 24. Manoeuvres at the roller shutters are enough to cause this position sensor to transmit a detection signal early to the evaluation device 24 with the result that where necessary an attempted break-in can be noticed very early. The signal-triggering element is fixed to the inside of the roller shutters.

Furthermore an external glassbreak sensor can additionally be connected to the evaluation device 24 and/or the transmitter 16. The glassbreak vibration detector can also be fixed in conventional manner to the pane of glass 34, wherein the leads to the evaluation device 24 are run in the handle fitting 3.

The first sensor 8, and a plug-in locking part 6 provided with the signal-triggering element 12, which can be exchanged for the existing plug-in locking part of the olive-shaped window or door fitting, can be added on to an existing olive-shaped window or door fitting. Such an add-on would permit the use of existing handles 4 including the handle fittings 2 without it showing from the outside that the handle is provided with a monitoring device.

Alternatively it can be provided that the first sensor 8, and a plug-in locking part provided with the signal-triggering element 12, which can be exchanged for the existing plug-in locking part 6 of the handle fitting 2, form an add-on unit with its own module housing 26 which can be inserted between the handle fitting and the window or door. In this case an already present handle 4 including the handle fitting 2 can also be used, wherein the module housing 26 of the monitoring and alarm module 1 merely has another plug-in locking part added on.

Between the window or the door and the handle fitting 2 or the housing 26 a drill-resistant steel plate 11 can be arranged which protects the electronic elements and the power supply against destruction.

The monitoring and alarm module 1 has at least one sensor device, e.g. comprising a sealed-contact switch 8, which is positioned at and fixed to the handle fitting 2 or the module housing 26 such that the sealed-contact switch 8 extends, in a specific swivel position of the handle, substantially parallel to an edge of the plug-in locking part 6, square in cross-section.

As can be seen from FIG. 2, the sealed-contact switch 8 extends for example parallel to the narrow edge of the rectangular handle fitting 2, while the leads are run parallel to the longitudinal edges of the handle fitting 2 up to an evaluation device 24. The evaluation device 24 can be connected to a transmitter 16 which can transmit the report signal of the monitoring device 24 to a central monitoring station or to the acoustic and/or visual signal transmitter 17.

Provided in the lower part of the module housing 26 is a compartment for an electricity-supply device 18 which can consist of a battery or a cell. The cell can optionally be fed by a solar cell.

The sealed-contact switch 8 can be located on a base plate 10 which can be added on to a handle fitting 2 customary in the trade. The plug-in locking part 6 with a magnet as signal-triggering element 12 is, if added on, exchanged for an existing plug-in locking part. A further sensor 14 which is likewise connected to the evaluation device 24 can be arranged in the module housing 26. Using the second sensor 14, it can be established by means of a signal-triggering element attached to the fixed frame of the window or door whether the door wing or window wing is being opened.

All the lever positions of the handle 4 can be detected by the evaluation device 24 from the combination of the signals of the first and second sensor 8, 14, with the result that a differentiated report signal can be transmitted via the transmitter 16 or a cable connection to the central monitoring station or directly to the signal transmitter 17 incorporated into the module housing 26.

### WINDOW OR DOOR

The present invention relates to a window or a door according to the preamble of claim 1 and to an olive-shaped window or door fitting for such a window or such a door according to the preamble of claim 4.

With such a window or with such a door as has become known from DE 296 03 917 U1, the module housing accommodating the monitoring and alarm module is connected as separate housing to a housing for the handle fitting and together with this is fitted onto the surface of the wing frame, wherein a handle plug penetrates, and extends beyond, both the handle fitting housing and the module housing in order to then be connected rotation-resistant to the closing mechanism in the wing frame in already known manner.

With this known embodiment, the handle plug connected rotation-resistant to the swivellable handle must have an excess length corresponding to the height of the module housing. Moreover, the module housing fitted onto the inner surface of the wing frame brings with it the danger that the monitoring and alarm module is already visible to potential intruders from the outside of the wing frame, added to which is the fact that this fit offers a design which is not acceptable to everyone.

Therefore the object of the present invention is to produce a window or a door or an olive-shaped window fitting or door fitting of the type named at the outset in which handles such as are customary in other windows or doors can be used and lead to an acceptable design.

To achieve this object, the features given in claim 1 or in claim 4 are provided with a window or a door or an olive-shaped window or door fitting of the type named.

By the measures according to the invention it is achieved that the wing frame concerned looks the same from the outside in the handle area, regardless of whether an olive-shaped window or door fitting with or without a monitoring and alarm module is provided. In purely design terms this also means that in both cases the handle or handle plug can be formed in the same way.

A form that is advantageous in terms of production engineering results if the features according to claim 2 or those according to claim 5 are provided.

A further advantageous form results from the features according to claim 3, as through this spatial arrangement the magnet to be allocated can be brought into the immediate vicinity of the monitoring and alarm module and thus a weaker magnetic field is sufficient, which simultaneously increases responsiveness if there is an unauthorized attempt at opening.

Further details of the invention are to be found in the following description in which the invention is described and illustrated in more detail with the help of the embodiment example represented in the drawing.

There are shown in:

FIG. 1 a perspective view of a preferred embodiment example of the invention,

FIG. 2 a partial longitudinal section through the monitoring and alarm module, but with the olive-shaped fitting attached, and

FIG. 3 a section along the line III-III of FIG. 2.

FIG. 1 shows an olive-shaped window or door fitting 10 with a handle 4 housed swivellable in a handle fitting 2 and with an autonomous monitoring and alarm module 1 arranged in a module housing 26. The monitoring and alarm module 1 has its own power supply 18 and is therefore independent of the power feed.

FIG. 1 shows an installation version for integrating the monitoring and alarm module 1 in the frame 5 of a window or door wing. The monitoring and alarm module is arranged sunk into a recess 30 of the wing frame 5, with the result that the olive-shaped window or door fitting 10 sits on the wing frame 5 like a standard version with no alarm device.

The installation version is shown in which the olive-shaped window or door fitting 10 is of conventional construction, wherein a handle plug or plug-in locking part 6 is pushed, rotation-resistant, with the handle 4, through the monitoring and alarm module 1 and is fitted jointly with this.

The olive-shaped window or door fitting 10 can however also form a structural unit with the monitoring and alarm module 1.

The monitoring and alarm module 1 is provided with a handling noise sensor 15 which is used as a glassbreak sensor and which is directed towards a pane of glass 34 and can selectively record sound frequencies which occur when glass is broken. If glass is broken, an alarm signal is transmitted to an evaluation device 24. The handling noise sensor 15 operates particularly reliably if it is arranged sunk into the recess 30, as it is then largely shielded from interfering noises.

In order even to better transmit to the handling noise sensor the sound frequencies occurring when glass is broken, a sound duct 32 can be provided in the wing frame 5, running between the side glass edge of the pane of glass 34 and ending opposite the handling noise sensor 15 in the module housing 26.

The module housing 26 can furthermore have on its front an integrated acoustic signal transmitter 17 which for example consists of a siren. Alternatively or additionally visual signal transmitters, such as for example a stroboscope light or LED lights, can also be provided.

Finally, on the front of the module housing 26, several status displays 19 can be arranged which can display the status of the battery or of the cell 18 and the status of the monitoring and alarm module 1 or of the evaluation unit 24. For example it could also be displayed whether there is a radio link to a central monitoring station. The monitoring and alarm module 1 forms an autonomous alarm system which is independent of the power supply and functions fully automatically. No activation or deactivation of the monitoring and alarm module 1 is necessary. Malfunctions are almost completely ruled out. Even in the case of sabotage e.g. if high-intensity radio waves are superimposed, at least the triggering of a local alarm is still ensured. Further protection against sabotage can be provided by a field-strength measurement sensor which operates an alarm if measured field-strength values change.

It is understood that the olive-shaped window or door fitting 10 with the monitoring and alarm module 1 can also be used autonomously without a central monitoring station and radio transmission of report signals to this.

FIGS. 2 and 3, which start from a module housing 26 fitted onto the wing frame 5, show details of the monitoring and alarm module 1 as is also used in the preferred embodiment example of the invention according to FIG. 1.

The monitoring and alarm module 1 serves in particular to secure windows and doors encased in a wing frame 5, with a swivellable handle 4 housed in a handle fitting 2 and with a, here replaceable, handle plug or plug-in locking part 6, connected to the handle 4. A sensor device in the module housing 26 detects the swivel actuation of the handle 4 with a first sensor 8 and delivers a first detection signal to the evaluation device 24.

A signal-triggering element 12 is arranged in the plug-in locking part 6, wherein the first sensor 8 is attached to the plug-in locking part 6 vis-à-vis the signal-triggering element 12 such that, when the handle 4 is moved out of a predefined swivel position, the first sensor 8 delivers the first detection signal to the evaluation device. Arranged in the module housing 26 is a second sensor 14 which, when the window or door wing is in the open position, supplies a second detection signal to the evaluation device 24. The evaluation device 24 recognizes all locking states from the combination of the two detection signals.

The monitoring and alarm module 1 makes it possible not only to monitor the swivel actuation of the handle 4 but also to analyze the handle position and send a corresponding report signal.

The evaluation device 24 receives the signals from all the sensors 8, 14, 15 and from these can recognize the locking state of the handle. Even if the window or the door is opened without the handle 4 being actuated, there is at least a second detection signal, with the result that in this case too a corresponding report signal can be generated.

It can be provided that a transmitter 16 transmits the detection signals or the report signal of the evaluation device 24 wirelessly to the central monitoring station.

It is provided here that the first sensor 8 detects the position of the plug-in locking part 6 in contact-less manner. Such a contact-less recording of the position of the plug-in locking part 6 is wear-free and extensively protected against interfering influences. Alternatively the position of the plug-in locking part 6 can be mechanically scanned.

The evaluation device 24 consists of a logic circuit which generates a report signal differentiated according to the incoming detection signals.

The sensor 16 can be integrated into the handle fitting 2 with the result that, to install the monitoring device according to the invention, it is merely necessary to replace the handle fitting 2 with the plug-in locking part 6. The power supply is in this case likewise integrated into the handle fitting 2.

The first sensor 8 preferably consists of a contactor which detects the position of a magnet attached in or to the plug-in locking part 6 as a signal-triggering element 12. The first sensor 8 consists of a sealed-contact switch which encloses the plug-in locking part 6 in a U-shape or circularly. It is possible to monitor different swivel positions of the handle with a single sensor 8. When using an N/O contact as sealed-contact switch, the switch is open in a swivel position of the handle 4 in which the magnet at the plug-in locking part 6 is opposite the sealed-contact switch, wherein the sealed-contact switch is closed as soon as the handle 4 is swiveled slightly out of this position.

The sealed-contact switch consists of a switch body lying opposite the signal-triggering element 12 when the handle 4 is in the closed position and projecting at right-angles or circularly from this switch body.

The second sensor 14 in the module housing 26 possesses a magnet switch which is actuated by a magnet attached to the fixed frame of the window or door. The second sensor 14 thus establishes whether the window or the door has been opened.

Furthermore a position sensor integrated into the monitoring and alarm module 1 for roller shutters can transmit a third detection signal to the evaluation device 24. Manoeuvres at the roller shutters are enough to cause this position sensor to transmit a detection signal early to the evaluation device 24 with the result that where necessary an attempted break-in can be noticed very early. The signal-triggering element is fixed to the inside of the roller shutters.

Furthermore an external glassbreak sensor can additionally be connected to the evaluation device 24 and/or the transmitter 16. The glassbreak vibration detector can also be fixed in conventional manner to the pane of glass 34, wherein the leads to the evaluation device 24 are run in the handle fitting 3.

The first sensor 8, and a plug-in locking part 6 provided with the signal-triggering element 12, which can be exchanged for the existing plug-in locking part of the olive-shaped window or door fitting, can be added on to an existing olive-shaped window or door fitting. Such an add-on would permit the use of existing handles 4 including the handle fittings 2 without it showing from the outside that the handle is provided with a monitoring device.

Alternatively it can be provided that the first sensor 8, and a plug-in locking part provided with the signal-triggering element 12, which can be exchanged for the existing plug-in locking part 6 of the handle fitting 2, form an add-on unit with its own module housing 26 which can be inserted between the handle fitting and the window or door. In this case an already present handle 4 including the handle fitting 2 can also be used, wherein the module housing 26 of the monitoring and alarm module 1 merely has another plug-in locking part added on.

Between the window or the door and the handle fitting 2 or the housing 26 a drill-resistant steel plate 11 can be arranged which protects the electronic elements and the power supply against destruction.

The monitoring and alarm module 1 has at least one sensor device, e.g. comprising a sealed-contact switch 8, which is positioned at and fixed to the handle fitting 2 or the module housing 26 such that the sealed-contact switch 8 extends, in a specific swivel position of the handle, substantially parallel to an edge of the plug-in locking part 6, square in cross-section.

As can be seen from FIG. 2, the sealed-contact switch 8 extends for example parallel to the narrow edge of the rectangular handle fitting 2, while the leads are run parallel to the longitudinal edges of the handle fitting 2 up to an evaluation device 24. The evaluation device 24 can be connected to a transmitter 16 which can transmit the report signal of the monitoring device 24 to a central monitoring station or to the acoustic and/or visual signal transmitter 17.

Provided in the lower part of the module housing 26 is a compartment for an electricity-supply device 18 which can consist of a battery or a cell. The cell can optionally be fed by a solar cell.

The sealed-contact switch 8 can be located on a base plate 10 which can be added on to a handle fitting 2 customary in the trade. The plug-in locking part 6 with a magnet as signal-triggering element 12 is, if added on, exchanged for an existing plug-in locking part. A further sensor 14 which is likewise connected to the evaluation device 24 can be arranged in the module housing 26. Using the second sensor 14, it can be established by means of a signal-triggering element attached to the fixed frame of the window or door whether the door wing or window wing is being opened.

All the lever positions of the handle 4 can be detected by the evaluation device 24 from the combination of the signals of the first and second sensor 8, 14, with the result that a differentiated report signal can be transmitted via the transmitter 16 or a cable connection to the central monitoring station or directly to the signal transmitter 17 incorporated into the module housing 26.

1-5. (canceled)

6. A window or door comprising:
a wing frame for encasing a pane of glass and having a recess,
an olive-shaped window or door fitting having a handle fitting, a handle swivellably mounted in the handle fitting, and a module housing accommodating a monitoring and alarm module having a plurality of sensor devices and an evaluation unit, wherein the module housing is arranged sunk into the recess of the wing frame.

7. The window or door as recited in claim 6, wherein the module housing is formed so as to be sunk, integrated, into the recess of the wing frame.

8. The window or door as recited in claim 6, wherein the handle fitting forms a structural unit with at least one of the monitoring and alarm module and the module housing.

9. The window or door as recited in claim 6, wherein one of the sensor devices has a contactor and a magnet allocated to the contactor, the magnet disposed adjacent to the module housing on a fixed frame of the window or door.

10. An olive-shaped window or door fitting for a window or a door, comprising:
a handle fitting;
a handle swivellably mounted in the handle fitting;
a module housing;
a monitoring and alarm module accommodated in the module housing and having a plurality of sensor devices and an evaluation unit, wherein the module housing is arranged sunk integrated into a recess of a wing frame of the window or door.

11. An olive-shaped window or door fitting as recited in claim 9, wherein the handle fitting forms a structural unit with at least one of the monitoring and alarm module and the module housing.
